(19) United States
(12) Patent Application Publication
(10) Pub. No.: US 2013/0100137 A1
(43) Pub. Date: Apr. 25, 2013

(54) COMPUTING DEVICE, STORAGE MEDIUM AND METHOD FOR ANALYZING 2D GRAPHIC FILES OF MEASUREMENT PRODUCTS

(71) Applicants: CHIH-KUANG CHANG, Tu-Cheng (TW); XIN-YUAN WU, Shenzhen City (CN); YI LIU, Shenzhen City (CN)

(72) Inventors: CHIH-KUANG CHANG, Tu-Cheng (TW); XIN-YUAN WU, Shenzhen City (CN); YI LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/555,084

(22) Filed: Jul. 21, 2012

(30) Foreign Application Priority Data
Oct. 19, 2011 (CN) 201110320350.2

(51) Int. Cl. G06T 11/20

(52) U.S. Cl. 345/441

(57) ABSTRACT

In a method for analyzing two-dimensional (2D) graphic files of a measurement product using a computing device, a 2D graphic file of the measurement product is obtained from a storage device. The method analyzes the geometrical data to generate the 2D graphic objects, sets characteristic values of the 2D graphic objects, and parses code values of the 2D graphic objects according to the characteristic codes. The method analyzes a coordinate value of each of the 2D graphic objects according to the geometrical data of the file array, and calculates a normal vector of each of the 2D graphic objects according to the characteristic code and the coordinate value of the 2D graphic object. A 2D drawing is displayed on a display device according to each of the 2D graphic objects and the corresponding normal vector.

### BACKGROUND

1. Technical Field

Embodiments of the present disclosure relate to file analysis systems and methods, and particularly to a computing device, a storage medium, and a method for analyzing two-dimensional (2D) graphic files of a measurement product.

2. Description of Related Art

Oftentimes, many computer aided design (CAD) vendors use geometrical data of a graphic file to design a measurement product. Then the vendors can manufacture the measurement product according to the geometrical data. Problem arise when the vendors export the geometrical data to a CAD system for further analysis. However, the vendors cannot analyze a drawing exchange format (DXF) graphic file to obtain two-dimensional (2D) drawings using the CAD system, and also cannot extract graphic elements (e.g., points, lines, and circles) from the 2D drawings. To analyze the DXF graphic file based on the CAD system, the DXF graphic file should be converted to a compatible format graphic file such as a DWG format using a special drawing conversion system, which is costly and inefficient.

### BRIEF DESCRIPTION OF THE DRAWINGS

FIG. 1 is a block diagram of one embodiment of a computing device including a graphic file analysis system.

FIG. 2 is a flowchart of one embodiment of a method for analyzing 2D graphic files of a measurement product using the computing device of FIG. 1.

FIG. 3 is a schematic diagram illustrating one example of a DXF graphic file of the measurement product.

FIG. 4 is a schematic diagram illustrating one example of geometrical data of the 2D graphic file stored in a file array T1 with a line arrangement.

FIG. 5 is a schematic diagram illustrating one example of different normal vectors of 2D graphic objects based an object array T2.

FIG. 6 is a schematic diagram illustrating one example of a 2D drawing of the measurement product.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of a non-transitory computer-readable medium include CDs, DVDs, flash memory, and hard disk drives.

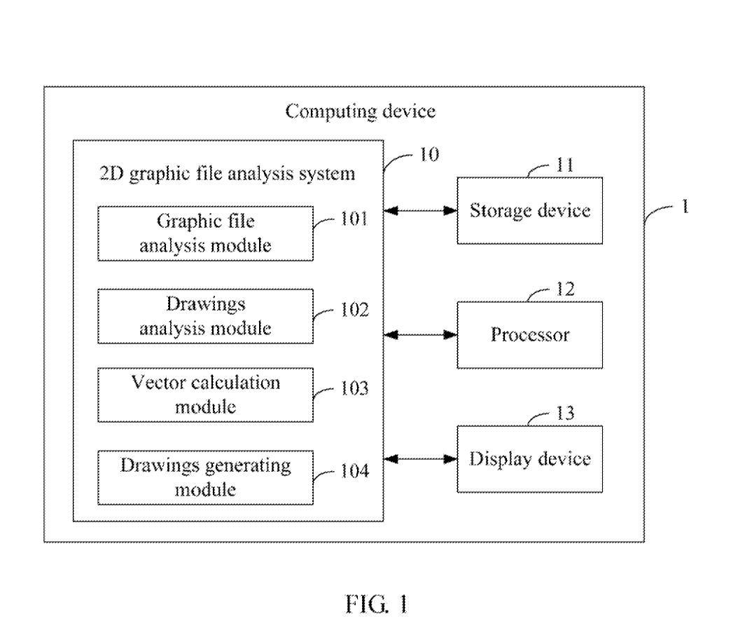

FIG. 1 is a block diagram of one embodiment of a computing device 1 including a graphic file analysis system 10. In the embodiment, the computing device 1 further includes a storage device 11, a processor 12, and a display device 13. The graphic file analysis system 10 may include a plurality of functional modules that are stored in the storage device 11 and executed by the at least one processor 12. FIG. 1 is only one example of the computing device 1, other examples may include more or fewer components than those shown in the embodiment, or have a different configuration of the various components.

The storage device 11 stores a plurality of drawing exchange format (DXF) graphic files of a product to be measured (hereinafter “the measurement product”). In the embodiment, each of the DXF graphic files is a two-dimensional (2D) measurement graphic file that includes a plurality of geometrical data on the measurement product. The geometrical data are used to describe graphic elements of the measurement product, such as points, lines, and circles. In one embodiment, the storage device 11 may be an internal storage device, such as a random access memory (RAM) for temporary storage of information, and/or a read only memory (ROM) for permanent storage of information. In some embodiments, the storage device 11 may also be an external storage device, such as an external hard disk, a storage card, or a data storage medium.

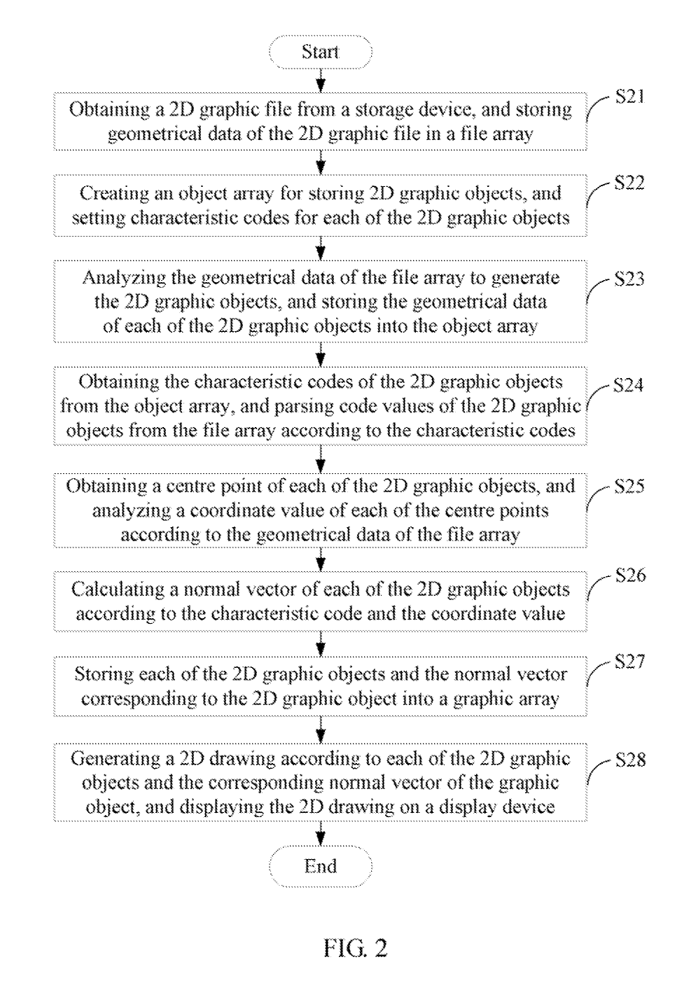

In one embodiment, the graphic file analysis system 10 includes a graphic file analysis module 101, a drawings analysis module 102, a vector calculation module 103, and a drawings generating module 104. The modules 101-104 may comprise computerized instructions in the form of one or more programs that are stored in the storage device 11 and executed by the at least one processor 12. A detailed descriptions of each module will be given in FIG. 2 as described in the following paragraphs.

FIG. 2 is a flowchart of one embodiment of a method for analyzing 2D graphic files of a measurement product using the computing device 1 of FIG. 1. In the embodiment, the measurement product may be a motherboard of a computer, or a printed circuit board (PCB) of an electronic device. Depending on the embodiment, additional steps may be added, others removed, and the ordering of the steps may be changed.

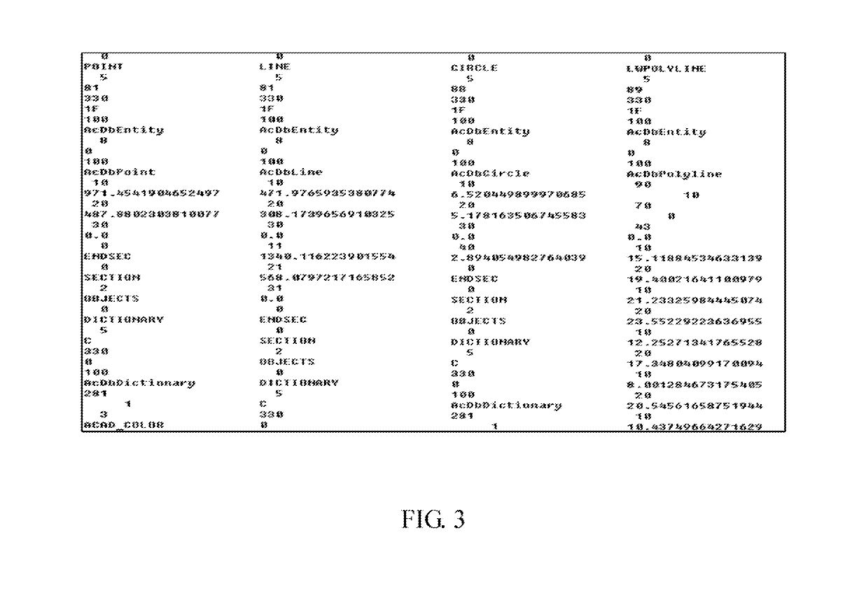

In step S21, the graphic file analysis module 101 obtains a 2D graphic file of the measurement product from the storage device 11, and stores geometrical data of each line of the 2D graphic file into a file array T1. As shown in FIG. 3, the 2D graphic file has a DXF format and is stored in the storage device 11. The geometrical data may include a plurality of characteristic codes and a code value corresponding to each of the characteristic codes, which are used to describe graphic elements of the product, such as points, lines, and circles. Each of the characteristic codes and the code value are stored in the 2D graphic file with arrangement of one by one line.

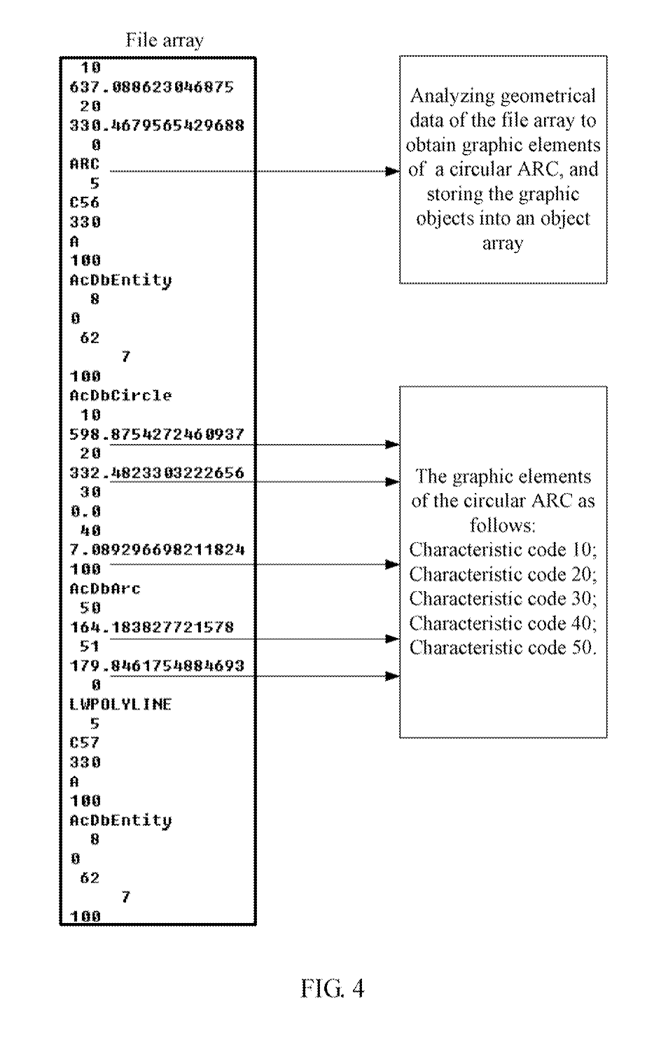

In step S22, the graphic file analysis module 101 creates an object array T2 for storing 2D graphic objects, and sets a characteristic code for each of the 2D graphic objects. In one embodiment, the 2D graphic objects may be rectangles, polygons, circles, or arcs. Each of the 2D graphic objects include a name of the 2D graphic object, a coordinate value of the 2D graphic object, and graphic parameters of the 2D graphic object. Take an arc as a 2D graphic object, the graphic parameters of the arc may include a centre point, a radius, an arc length, and an angle of the arc. Referring to FIG. 4, the characteristic code 10 and the characteristic code 20 represent a coordinate value of the centre point. The characteristic code 30 represents a length of the arc. The characteristic code 40 represents a code value of the radius, and the characteristic code 50 represents a code value of the angle.

In step S23, the graphic file analysis module 101 analyzes the geometrical data of the file array T1 to generate the 2D graphic objects, and stores the geometrical data of each of the 2D graphic objects into the object array T2. In the embodiment, the graphic file analysis module 101 may store the geometrical data of each of the 2D graphic objects into the object array T2 according to a type of the 2D graphic objects, such as rectangles, polygons, circles, or arcs, for example.

In step S24, the drawings analysis module 102 obtains the characteristic codes of the 2D graphic objects from the object array T2, and parses code values of the 2D graphic objects from the file array T1 according to the characteristic codes. Referring to FIG. 4, the characteristic code 10 represents that an X-coordinate value of the centre point is 598.87542760937, and the characteristic code 20 represents that a Y-coordinate value of the centre point is 332.4823303222656. The characteristic code 30 represents that the arc length is 7.089296698211824 mm. The characteristic code 40 represents that the code value of the radius is 164.183827721578 mm, the characteristic code 50 represents that the code value of the angle is 179.8461754884693 degrees.

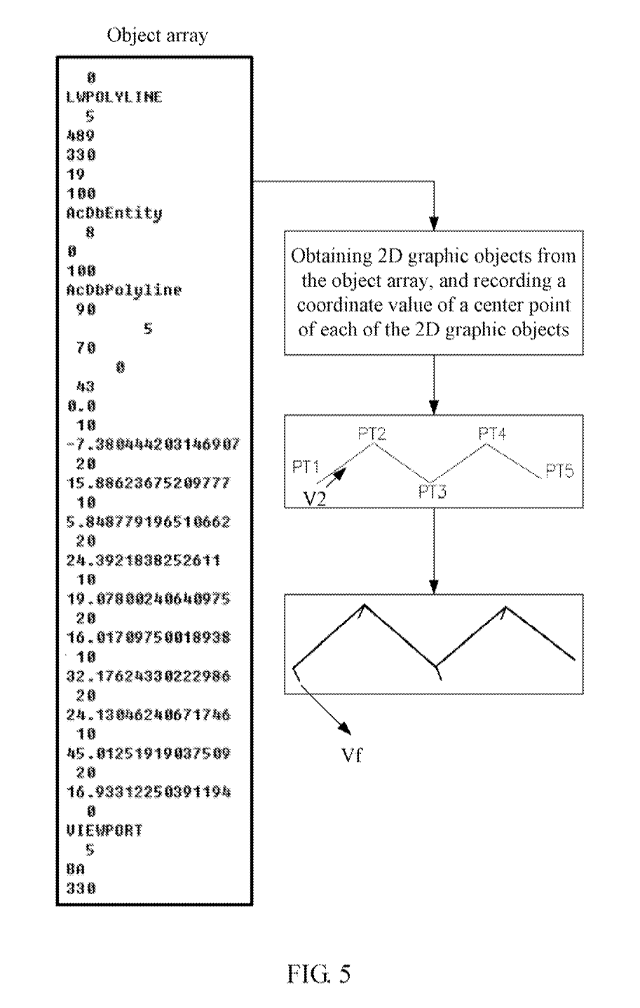

In step S25, the drawings analysis module 102 obtains a centre point of each of the 2D graphic objects, and analyzes a coordinate value of each of the centre points according to the geometrical data of the file array T1. Referring to FIG. 5, the drawings analysis module 102 obtains a first point PT1 as the centre point of a circle, and analyzes the coordinate value of the point PT1 as (−7.3804, 15.8862). The drawings analysis module 102 obtains a second point PT2 as the centre point of a rectangle, and analyzes the coordinate value of the point PT2 as (5.8487, 24.3921). The drawings analysis module 102 obtains a third point PT3 as the centre point of a polygon, and analyzes the coordinate value of the point PT3 as (19.0780, 16.0170).

In step S26, the vector calculation module 103 calculates a normal vector of each of the 2D graphic objects according to the characteristic code and the coordinate value of the 2D graphic object. Referring to FIG. 5, the vector calculation module 103 calculates a horizontal vector V2 of each of the 2D graphic objects using a vector calculation algorithm as follows: D²=(PT2.x−PT1.x)²+(PT2.y−PT1.y)², V2.x=(PT2.x−PT1.x)/D, V2.y=(PT2.y−PT1.y)/D, and V2.z=(PT2.z−PT1.z)/D, and calculates the normal vector Vf of each of the 2D graphic objects according to the horizontal vector V2 using a vectorial difference algorithm as follows: Vfx=V1.y×V2.z−V2.y×V1.z, Vf.y=V1.z×V2.x−V2.z×V1.x, Vf.z=V1.x×V2.y−V2.x×V1.y, where the parameter x represents a normal vector of 2D graphic object the based on the X axis of the coordinate system, and the parameter y represents a normal vector of 2D graphic object based on the Y axis of the coordinate system.

In step S27, the drawings generating module 104 stores each of the 2D graphic objects and the normal vector corresponding to the 2D graphic object into a graphic array T3. For example, if the graphic object is a circle, the drawings generating module 104 stores the centre point, the radius and the normal vector of the circle into the graphic array T3.

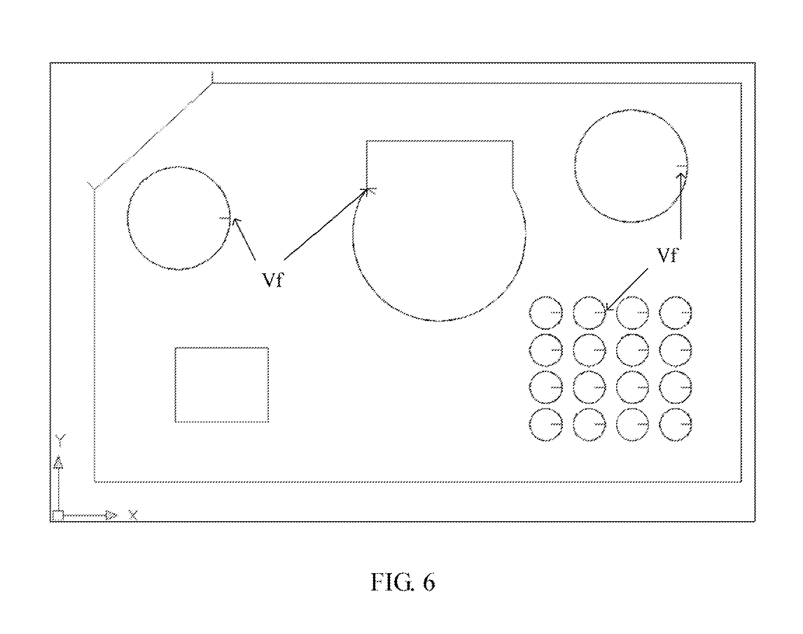

In step S28, the drawings generating module 104 generates a 2D drawing according to each of the 2D graphic objects and the corresponding normal vector of the 2D graphic object stored in the graphic array T3, and displays the 2D drawing on the display device 13 of the computing device 1. Referring to FIG. 6, which is a schematic diagram illustrating one example of a 2D drawing of the measurement product. The 2D drawing includes a plurality of circles, rectangles, polygons, and arcs. In one embodiment, the 2D drawing can be automatically generated when the 2D graphic objects and the corresponding normal vectors are input to a computer aided design (CAD) system, which may be a CADR1 system, a CAD2000 system, or a CADR12 system.

All of the processes described above may be embodied in, and fully automated via, functional code modules executed by one or more general purpose processors of computing devices. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage device;
at least one processor; and
one or more programs stored in the storage device and executed by the at least one microprocessor, the one or more programs comprising:
a graphic file analysis module that obtains a two-dimensional (2D) graphic file of a measurement product from the storage device, stores geometrical data of the 2D graphic file into a file array, creates an object array for storing 2D graphic objects, sets a characteristic code for each of the 2D graphic objects, and analyzes the geometrical data stored in the file array to generate the 2D graphic objects;
a drawings analysis module that obtains the characteristic codes of the 2D graphic objects from the object array, parses code values of the 2D graphic objects from the file array according to the characteristic codes, obtains a centre point of each of the 2D graphic objects, and analyzes a coordinate value of each of the centre points according to the geometrical data of the file array;
a vector calculation module that calculates a normal vector of each of the 2D graphic objects according to the characteristic code and the coordinate value of the 2D graphic object; and
a drawings generating module that generates a 2D drawing according to each of the 2D graphic objects and the corresponding normal vector, and displays the 2D drawing on a display device of the computing device.

2. The computing device according to claim 1, wherein the drawings generating module further stores each of the 2D graphic objects and the normal vector corresponding to the 2D graphic object into a graphic array.

3. The computing device according to claim 1, wherein the graphic file analysis module stores the geometrical data of each of the 2D graphic objects into the object array according to a type of the 2D graphic objects.

4. The computing device according to claim 1, wherein the vector calculation module calculates a horizontal vector of each of the 2D graphic objects using a vector calculation algorithm, and calculates the normal vector of each of the 2D graphic objects according to the horizontal vector using a vectorial difference algorithm.

5. The computing device according to claim 1, wherein the 2D graphic file is a drawing exchange format (DXF) graphic file that includes a plurality of geometrical data, which are used to describe graphic elements of the measurement product.

6. The computing device according to claim 1, wherein each of the 2D graphic objects comprises a graph name of the 2D graphic object, a coordinate value of the 2D graphic object, and graph parameters of the 2D graphic object.

7. A method for analyzing two-dimensional (2D) graphic files of a measurement product using a computing device, the method comprising:
obtaining a 2D graphic file of the measurement product from a storage device of the computing device, and storing geometrical data of the 2D graphic file into a file array;
creating an object array for storing 2D graphic objects, and setting a characteristic code for each of the 2D graphic objects;
analyzing the geometrical data stored in the file array to generate the 2D graphic objects;
obtaining the characteristic codes of the 2D graphic objects from the object array, and parsing code values of the 2D graphic objects from the file array according to the characteristic codes;
obtaining a centre point of each of the 2D graphic objects, and analyzing a coordinate value of each of the centre points according to the geometrical data of the file array;
calculating a normal vector of each of the 2D graphic objects according to the characteristic code and the coordinate value of the 2D graphic object; and
generating a 2D drawing according to each of the 2D graphic objects and the corresponding normal vector, and displaying the 2D drawing on a display device of the computing device.

8. The method according to claim 7, further comprising:
storing each of the 2D graphic objects and the normal vector corresponding to the 2D graphic object into a graphic array.

9. The method according to claim 7, wherein the geometrical data of each of the 2D graphic objects is stored in the object array according to a type of the 2D graphic objects.

10. The method according to claim 7, wherein the normal vector of each of the 2D graphic objects is calculated by performing steps of:
calculating a horizontal vector of each of the 2D graphic objects using a vector calculation algorithm; and
calculating the normal vector of each of the 2D graphic objects according to the horizontal vector using a vectorial difference algorithm.

11. The method according to claim 7, wherein the 2D graphic file is a drawing exchange format (DXF) graphic file that includes a plurality of geometrical data, which are used to describe graphic elements of the measurement product.

12. The method according to claim 7, wherein each of the 2D graphic objects comprises a graph name of the 2D graphic object, a coordinate value of the 2D graphic object, and graph parameters of the 2D graphic object.

13. A non-transitory computer-readable storage medium having stored thereon instructions that, when executed by at least one processor of a computing device, causes the computing device to perform a method for analyzing two-dimensional (2D) graphic files of a measurement product, the method comprising:
obtaining a 2D graphic file of the measurement product from a storage device of the computing device, and storing geometrical data of the 2D graphic file into a file array;
creating an object array for storing 2D graphic objects, and setting a characteristic code for each of the 2D graphic objects;
analyzing the geometrical data stored in the file array to generate the 2D graphic objects;
obtaining the characteristic codes of the 2D graphic objects from the object array, and parsing code values of the 2D graphic objects from the file array according to the characteristic codes;
obtaining a centre point of each of the 2D graphic objects, and analyzing a coordinate value of each of the centre points according to the geometrical data of the file array;
calculating a normal vector of each of the 2D graphic objects according to the characteristic code and the coordinate value of the 2D graphic object; and
generating a 2D drawing according to each of the 2D graphic objects and the corresponding normal vector, and displaying the 2D drawing on a display device of the computing device.

14. The storage medium according to claim 13, wherein the method further comprises:
storing each of the 2D graphic objects and the normal vector corresponding to the 2D graphic object into a graphic array.

15. The storage medium according to claim 13, wherein the geometrical data of each of the 2D graphic objects is stored in the object array according to a type of the 2D graphic objects.

16. The storage medium according to claim 13, wherein the normal vector of each of the 2D graphic objects is calculated by performing the steps of:
calculating a horizontal vector of each of the 2D graphic objects using a vector calculation algorithm; and
calculating the normal vector of each of the 2D graphic objects according to the horizontal vector using a vectorial difference algorithm.

17. The storage medium according to claim 13, wherein the 2D graphic file is a drawing exchange format (DXF) graphic file that includes a plurality of geometrical data, which are used to describe graphic elements of the measurement product.

18. The storage medium according to claim 13, wherein each of the 2D graphic objects comprises a graph name of the 2D graphic object, a coordinate value of the 2D graphic object, and graph parameters of the 2D graphic object.
